(19) United States
(12) Patent Application Publication
(10) Pub. No.: US 2006/0151084 A1
(43) Pub. Date: Jul. 13, 2006

(54) Tyre for vehicle wheels with a reinforced bead

(76) Inventor: Antonio Serra, GENOVA (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/473,174

(22) PCT Filed: Mar. 15, 2002
(86) PCT No.: PCT/EP02/02901

§ 371 Date: Mar. 15, 2004

Related U.S. Application Data
(62) Division of application No. 60/281,406, filed on Apr. 5, 2001.

(30) Foreign Application Priority Data
Mar. 30, 2001 (EP) 01108106.4

(51) Int. Cl. B60C 15/06

(52) U.S. Cl. 152/541; 152/458; 428/295.1

(57) ABSTRACT

Tyre for vehicle wheels comprising; a) a carcass structure having at least one carcass ply associated with respective left and right bead wires, each bead wire being enclosed in a respective bead, said bead comprising a bead filler b) a belt structure comprising at least one belt strip applied circumferentially over said carcass structure; c) a tread band circumferentially superimposed on said belt structure; d) a pair of side walls applied laterally on opposite sides relative to said carcass structure; in which said bead filter is obtained by vulcanization of an elastomeric composition comprising discontinuous fibres and at least one elastomeric groups. The abovementioned bead filler is capable of having a positive influence on the performance qualities of the tyre, in particular on the performance qualifies at high speed, such as, for example, the cornering stability, the control on a wet surface and the ride comfort.

The present invention relates to a tyre for vehicle wheels.

More particularly, the present invention relates to a tyre for vehicle wheels which has a reinforced bead, said bead comprising a bead filler consisting of a vulcanized elastomeric composition comprising discontinuous fibres and at least one elastomeric polymer containing epoxide groups.

In general, a tyre comprises a carcass structure formed by at least one carcass ply shaped in a substantially toroidal configuration, the opposite lateral edges of which are associated with substantially inextensible respective annular structures, commonly known as “bead wires”, a tread band, a belt structure located between the carcass structure and the tread band, and a pair of sidewalls applied externally to said carcass structure. The portion of the tyre which comprises the abovementioned bead wires is called the bead, and its function is to fix the tyre onto a respective rim of a vehicle wheel. According to a conventional structure, the bead comprises a suitable rubber band, of substantially triangular cross section, commonly known as “bead filler”.

U.S. Pat. No. 4,532,291 discloses a bead filler composition comprising: (A) a reinforced elastomeric composition comprising a vulcanizable rubber and from 5 to 100 parts by weight, per 100 parts by weight of said vulcanizable rubber, of a thermoplastic polymer containing an amide group in the main chain (for example Nylon) in the form of short fibres, said vulcanizable rubber and said thermoplastic polymer being grafted together by means of a precondensed phenol-formaldehyde resin; (B) a diene rubber; and (C) carbon black. Examples of vulcanizable rubbers which are useful for this purpose are: natural rubber, cis-1,4-polybutadiene, polyisoprene, styrene/butadiene copolymers, isoprene-isobutylene copolymers, and the like. Natural rubber is preferred. Examples of diene rubbers (B) which are useful for this purpose are: natural rubber, polyisoprene, cis-1,4-polybutadiene, styrene/butadiene copolymers, isoprene/isobutylene copolymers, and the like, or blends thereof. Said composition is said to have a low Mooney viscosity and good processibility and, after vulcanization, a high elastic modulus and high flex cracking propagation resistance.

U.S. Pat. No. 4,824,899 discloses a bead filler composition comprising (A) from 50 to about 100 parts by Weight of carbon black; (B) from 1 to about 10 parts by weight of sulphur; and (C) from 1 to about 15 parts by weight of a metal salt of acrylic acid chosen from aluminium acrylate, zinc acrylate, nickel acrylate, cobalt acrylate, lead acrylate, iron acrylate, manganese acrylate, barium acrylate, calcium acrylate and magnesium acrylate. Said parts by weight are defined as parts by weight relative to 100 parts of natural rubber or of a blend of natural rubber with not more than 50% of a synthetic diene rubber. Examples of synthetic diene rubbers which are useful for this purpose are: polyisoprene, cis-polybutadiene, polybutadiene with a middle or high content of vinyl, syndiotactic polybutadiene and styrene/butadiene copolymers in emulsion or in solution. Said composition is said to be usable as bead filler and to give the tyre good durability, good ride comfort and good cornering stability.

U.S. Pat. No. 4,898,223 discloses a composition comprising a polyoctenamer, a cis-1,4-polyisoprene grafted with an alkyl methacrylate and at least one vulcanizable rubber chosen from natural rubber and synthetic rubbers containing a carbon-carbon double bond. Said composition is said to have good stiffness and to be usable as bead filler.

Japanese patent application JP 07/330 962 discloses a bead filler composition comprising: (A) a polyolefin; (B) a vulcanizable rubber; and (C) fibres of a thermoplastic polymer containing an amide group in the main chain (for example Nylon). Said composition is said to have, after vulcanization, a good elastic modulus and high flex cracking propagation resistance.

U.S. Pat. No. 4,871,004 discloses a composition comprising a vulcanizable elastomer and an effective amount of aramid fibres. Examples of vulcanizable elastomers which are useful for this purpose are: natural rubber, cis-1,4-polyisoprene, polybutadiene (in solution or in emulsion), styrene/butadiene copolymers (in solution or in emulsion), butyl rubbers and halobutyl rubbers, EPDM, butadiene/acrylonitrile rubbers, neoprene, vinylpolybutadiene and, in general, polymers with viscoelastic properties, or blends thereof. Said composition is said to be usable in all cases in which rubbers with a high level of hardness and/or a high modulus are required, in particular in vehicle tyres (for example as bead filler). One of the reasons which justifies the use of the abovementioned fibres is the improvement in the structural strength of the vulcanized manufactured product.

The Applicant has found that the use of reinforcing fibres in elastomeric compositions does not always lead to the desired mechanical and elastic properties being obtained. For example, elastomeric compositions comprising an elastomeric polymer, in particular natural rubber, and discontinuous fibres, have mechanical properties, in particular load at elongation, and elastic properties, in particular dynamic elastic modulus at high temperatures, that are unsatisfactory, in particular when said elastomeric compositions are used as bead filler. In addition, the abovementioned compositions show a high percentage of reversion which may lead to a decline in the properties of the final manufactured product, both in the case of an overvulcanization in the production stage, and during the use of this manufactured product. In particular, when they are used as bead filler, reversion phenomena may result in a deterioration of the road-holding of the tyre. Essentially, the reversion consists of a partial breaking and/or cyclization of the sulphur-based crosslinks between the polymer chains of the elastomeric composition, which may be attributed substantially to the high temperatures that are reached during the vulcanization operations and/or when the tyre is in use.

The Applicant has now found that it is possible to overcome the drawbacks outlined above by using, as bead filler for a tyre, an elastomeric composition comprising discontinuous fibres and at least one elastomeric polymer containing epoxide groups. Said composition, after vulcanization, has mechanical properties, in particular load at elongation, and elastic properties, in particular dynamic elastic modulus at high temperatures, that are such as to obtain a bead filler which is capable of having a positive influence on the performance qualities of the tyre, in particular on the performance qualities at high speed, such as, for example, the cornering stability, the control on a wet surface and the ride comfort. In addition, said performance qualities are substantially maintained over time by means of a significant reduction in the reversion phenomena.

According to a first aspect, the present invention thus relates to a tyre for vehicle wheels comprising:
a carcass structure having at least one carcass ply shaped in a substantially toroidal configuration, the opposite lateral edges of which are associated with respective left and right bead wires, each bead wire being enclosed in a respective bead, said bead comprising a bead filler;
a belt structure comprising at least one belt strip applied circumferentially over said carcass structure;
a tread band circumferentially superimposed on said belt structure;
a pair of sidewalls applied laterally on opposite sides relative to said carcass structure;
   in which said bead filler is obtained by vulcanization of an elastomeric composition comprising discontinuous fibres and at least one elastomeric polymer containing epoxide groups.

According to a further aspect, the present invention relates to an elastomeric composition comprising discontinuous fibres and at least one elastomeric polymer containing epoxide groups.

According to a further aspect, the present invention relates to a vulcanized elastomeric manufactured product obtained by vulcanizing an elastomeric composition comprising discontinuous fibres and at least one polymer containing epoxide groups.

According to one preferred embodiment, said elastomeric composition also comprises a diene elastomeric polymer not containing epoxide groups.

According to a further preferred embodiment, said elastomeric composition also comprises at least one reinforcing filler.

According to a further preferred embodiment, said elastomeric composition also comprises at least one thermosetting resin.

According to one preferred embodiment, the discontinuous fibres are aramid fibres, in particular short fibrillated poly(para-phenyleneterephthalamide) fibres (also known as aramid pulp), of the type known commercially as Kevlar® pulp from Du Pont or Twaron® pulp from Akzo, which are disclosed in U.S. Pat. No. 4,871,004 mentioned above, the description of which is incorporated herein by way of reference. Preferably, aramid fibres used according to the present invention have a configuration with a main trunk with a length (L) of between about 0.2 mm and about 0.5 mm, a diameter (D) of between about 0.005 mm and about 0.02 mm and an aspect ratio L/D of between about 10 and about 1 000, and a plurality of fibrils or small branches which extend outwards from said trunk over the entire length of the trunk and which have a diameter that is substantially smaller than the diameter of said trunk. The surface area of said fibres is between about 4 m²/g and about 20 m²/g. The surface area of the aramid fibres which may be used in the present invention is from about 30 to about 60 times greater than that of fibres having the same diameter but not comprising fibrils.

According to a preferred embodiment, the abovementioned aramid fibres may be used either as such or in the form of a predispersion in a suitable polymer matrix which serves as a vehicle, consisting of, for example, natural rubber, butadiene/styrene copolymers, ethylene/vinyl acetate copolymers, and the like. Preferably, a blend (“masterbatch”) in which the abovementioned fibres are dispersed in natural rubber, which is known by the trade name Kevlare Engineered Elastomer from Du Pont and which is composed of 23% by weight of Kevlar® and 77% by weight of natural rubber, is used.

It should be pointed out that although the discontinuous fibres that are preferred according to the present invention are chosen from the aramid fibres described above, said discontinuous fibres may also be chosen from: fibres based on other polyamides (for example Nylon), on polyesters, on polyolefins, on polyvinyl alcohol, or glass fibres.

According to one preferred embodiment, the discontinuous fibres are present in the elastomeric composition in an amount of between 2 phr and 12 phr, preferably between 4 phr and 10 phr.

For the purposes of the present description and the claims, the expression “phr” is intended to indicate the parts by weight of a given component of the elastomeric composition per 100 parts by weight of elastomeric base.

According to one preferred embodiment, the elastomeric polymer containing epoxide groups (which is also referred to for simplicity hereinbelow as “epoxidized elastomeric polymer”) is chosen from homopolymers and copolymers with elastomeric properties having a glass transition temperature (T_{g}) of less than 23° C. and preferably less than 0° C. Said epoxidized elastomeric polymer generally contains at least 0.05 mol %, preferably from 1 mol % to 70 mol %, even more preferably from 5 mol % to 60 mol %, of epoxide groups relative to the total number of moles of monomers present in the polymer. Blends of various elastomeric polymers containing epoxide groups, or blends of one or more epoxidized elastomeric polymers with one or more non-epoxidized elastomeric polymers, also fall within the present definition.

In the case of copolymers, these may have a random, block, grafted or also mixed structure. The average molecular weight of the elastomeric polymer containing epoxide groups is preferably between 10 000 and 1 000 000, more preferably between 50 000 and 500 000.

Epoxidized diene homopolymers or copolymers in which the base polymer structure, of synthetic or natural origin, is derived from one or more conjugated diene monomers, optionally copolymerized with monovinylarenes and/or polar comonomers, are preferred in particular.

Polymers derived from the (co)polymerization of diene monomers containing from 4 to 12, preferably from 4 to 8 carbon atoms, chosen, for example, from: 1,3-butadiene, isoprene, 2,3-dimethyl-1,3-butadiene, 3-butyl-1,3-octadiene, 2-phenyl-1,3-butadiene, and the like, or mixtures thereof, are particularly preferred. 1,3-butadiene and isoprene are particularly preferred.

Monovinylarenes which can optionally be used as comonomers generally contain from 8 to 20, preferably from 8 to 12, carbon atoms and can be chosen, for example, from: styrene; 1-vinylnaphthalene; 2-vinylnaphthalene; various alkyl, cycloalkyl, aryl, alkylaryl or arylalkyl derivatives of styrene, such as, for example: 3-methylstyrene, 4-propylstyrene, 4-cyclohexylstyrene, 4-dodecylstyrene, 2-ethyl-4-benzylstyrene, 4-p-tolylstyrene, 4-(4-phenylbutyl)styrene; and the like; or mixtures thereof. Styrene is particularly preferred. These monovinylarenes can optionally be substituted with one or more functional groups, such as alkoxy groups, for example 4-methoxystyrene, amino groups, for example 4-dimethylaminostyrene, and the like.

Various polar comonomers can be introduced into the base polymer structure, in particular vinylpyridine, vinylquinoline, acrylic and alkylacrylic acid esters, nitriles, and the like, or mixtures thereof, such as, for example: methyl acrylate, ethyl acrylate, methyl methacrylate, ethyl methacrylate, acrylonitrile, and the like.

Among the base polymer structures which are particularly preferred are: natural rubber, polybutadiene, polyisoprene, styrene/butadiene copolymers, butadiene/isoprene copolymers, styrene/isoprene copolymers, nitrile rubbers, and the like, or blends thereof.

In the case of copolymers, the amount of diene comonomer relative to the other comonomers is such as to ensure that the final polymer has elastomeric properties. In this sense, it is not possible generally to establish the minimum amount of diene comonomer required to obtain the desired elastomeric properties. As a guide, an amount of diene comonomer of at least 50% by weight relative to the total weight of the comonomers can generally be considered sufficient.

The preparation of the base diene polymer may be carried out according to known techniques, generally in emulsion, in suspension or in solution. The base polymer thus obtained is then subjected to epoxidation according to known techniques, for example by reaction in solution with an epoxidizing agent. This agent is generally a peroxide or a peracid, for example m-chloroperbenzoic acid, peracetic acid, and the like, or alternatively hydrogen peroxide in the presence of a carboxylic acid or a derivative thereof, for example acetic acid, acetic anhydride and the like, optionally mixed with an acid catalyst such as sulphuric acid. Further details regarding processes for epoxidizing elastomeric polymers are disclosed, for example, in U.S. Pat. No. 4,341,672 or by Schulz et al. in “Rubber Chemistry and Technology”, Vol. 55, pages 809 et seq.

Polymers containing epoxide groups which may also be used include elastomeric copolymers of one or more monoolefins with an olefinic comonomer containing one or more epoxide groups. The monoolefins may be chosen from: ethylene and x-olefins generally containing from 3 to 12 carbon atoms, such as, for example: propylene, 1-butene, 1-pentene, 1-hexene, 1-octene and the like, or mixtures thereof. The following are preferred: copolymers between ethylene and an α-olefin, and optionally a diene; homopolymers of isobutene or copolymers thereof with small amounts of a diene, which are optionally at least partially halogenated. The diene optionally present generally contains from 4 to 20 carbon atoms and is preferably chosen from: 1,3-butadiene, isoprene, 1,4-hexadiene, 1,4-cyclohexadiene, 5-ethylidene-2-norbornene, 5-methylene-2-norbornene, and the like. Among these, the following are particularly preferred: ethylene/propylene copolymers (EPR) or ethylene/propylene/diene copolymers (EPDM); polyisobutene; butyl rubbers; halobutyl rubbers, in particular chlorobutyl or bromobutyl rubbers; and the like, or blends thereof. Olefinic comonomers containing epoxide groups may be chosen, for example, from: glycidyl acrylate, glycidyl methacrylate, vinylcyclohexene monoxide, allyl glycidyl ether and methallyl glycidyl ether. The introduction of the epoxide groups by means of the abovementioned epoxidized comonomers may be carried out by copolymerization of the corresponding monomers according to known techniques, in particular by radical copolymerization in emulsion. When a diene comonomer is present, this comonomer may be used to introduce epoxide groups by means of an epoxidation reaction as described above.

According to one particularly preferred embodiment, said epoxidized elastomeric polymer is epoxidized natural rubber (ENR).

Examples of epoxidized elastomeric polymers which may be used in the present invention and which are currently commercially available are the Epoxyprene® products from Guthrie (epoxidized natural rubber—ENR).

The amount of epoxidized elastomeric polymer present in the elastomeric composition varies as a function of the amount of functional groups present and of the elastic properties which it is intended to obtain for the final manufactured product. Preferably, the amount of said epoxidized elastomeric polymer is between 30 phr and 100 phr, more preferably between 50 phr and 100 phr, even more preferably between 70 phr and 100 phr.

As stated above, the elastomeric composition may also comprise at least one diene elastomer not containing epoxide groups, of natural or synthetic origin, chosen, for example, from: natural rubber; polybutadiene; polyisoprene; styrene/butadiene copolymers; butadiene/isoprene copolymers; styrene/isoprene copolymers; butyl rubbers or halobutyl rubbers; nitrile rubbers; ethylene/propylene copolymers; ethylene/propylene/non-conjugated diene (such as, for example, norbornene, cyclooctadiene or dicyclopentadiene) terpolymers; and the like, or blends thereof. Natural rubber and polyisoprene are preferred. Preferably, said diene elastomer not containing epoxide groups is present in the elastomeric composition in an amount of between 0 phr and 70 phr, more preferably between 10 phr and 50 phr.

As mentioned above, the elastomeric composition may also comprise at least one reinforcing filler such as, for example, carbon black, silica, alumina, alumino-silicates, calcium carbonate, kaolin, and the like, or mixtures thereof, and preferably carbon black. Preferably, said reinforcing filler is present in the elastomeric composition in an amount of between 50 phr and 150 phr, more preferably between 60 phr and 100 phr.

As mentioned above, the elastomeric composition may also comprise at least one thermosetting resin. Preferably, said thermosetting resin is of the type such as resorcinol plus methylene donor, both in the two-component form (which then forms the thermosetting resin in situ) and in the precondensed form (condensed before being added to said elastomeric composition). Typically, the methylene donor is hexamethoxymethylmelamine (HMMM) or hexamethylenetetramine (HMT). Alternatively, thermosetting resins of other types such as, for example, epoxide/polyol, epoxide/diamine and epoxide/dicarboxylic acid resins; or resins obtained from the reaction of an alcohol with a diacid (alkyd resins); or phenolic resins obtained from the condensation of an optionally substituted phenol with an aldehyde such as, for example, formaldehyde, acetaldehyde, furfural, may also be used. In this case also, the two components may be added in situ or the resin precondensed beforehand may be added to the elastomeric composition. Preferably, said thermosetting resin is present in the elastomeric composition in an amount of between 0.5 phr and 15 phr, more preferably between 2 phr and 10 phr.

Said elastomeric composition also comprises a vulcanizing system chosen from those commonly used for diene elastomers. Said vulcanizing system generally comprises a sulphur-based vulcanizing agent together with one or more vulcanization activators and/or accelerators.

The vulcanizing agent more advantageously used is sulphur, or molecules containing sulphur (sulphur donors), with accelerators and activators that are known to those skilled in the art.

Activators that are particularly effective are zinc compounds, and in particular ZnO, ZnCO₃, zinc salts of saturated or unsaturated fatty acids containing from 8 to 18 carbon atoms such as, for example, zinc stearate, preferably formed in situ in the blend using ZnO and fatty acid. Other activators may be chosen from: BiO, PbO, Pb₃O₄, PbO₂, and mixtures thereof.

Accelerators that are commonly used may be chosen from: dithiocarbamates, guanidine, thiourea, thiazoles, sulphenamides, thiurams, amines, xanthates, and the like, or mixtures thereof.

Said elastomeric composition may also comprise other conventional components, such as antioxidants, anti-ageing agents, protecting agents, plasticizers, compatibilizers for the reinforcing filler, adhesives, anti-ozone agents, modifying resins, lubricants (for example mineral oils, vegetable oils, synthetic oils and the like, or mixtures thereof).

The abovementioned elastomeric composition may be prepared by mixing together the polymeric components with the reinforcing filler optionally present and with the other additives, according to techniques known in the art. The mixing may be carried out, for example, using an open blender of open-mill type, or an internal blender of the type with tangential rotors (Banbury) or with interlocking rotors (Intermix), or alternatively in continuous blenders of the Ko-kneader (Buss) or co-rotating or counter-rotating twin-screw type.

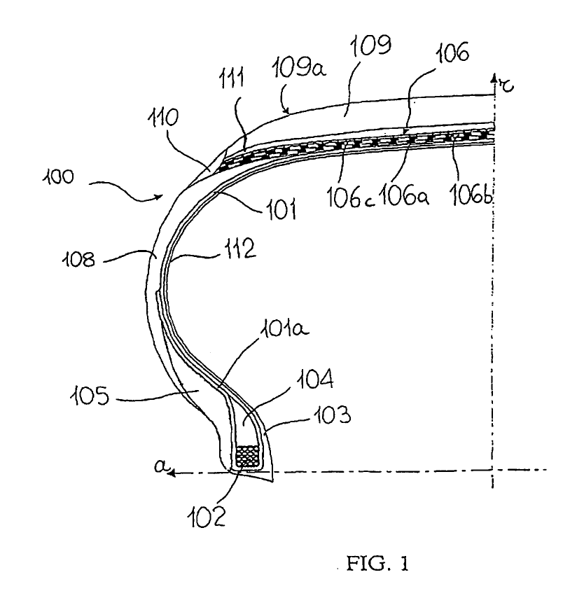

The present invention will now be further illustrated with the aid of a number of embodiment examples, with reference to the attached FIG. 1, which shows a view in cross section of a portion of a tyre made according to the invention.

“a” indicates an axial direction and “r” indicates a radial direction. For simplicity, FIG. 1 shows only a portion of the tyre, the remaining portion not shown being identical and symmetrically arranged with respect to the radial direction “r”.

The tyre (100) comprises at least one carcass ply (101) whose opposite lateral edges are associated with respective bead wires (102). The association between the carcass ply (101) and the bead wires (102), in this case, is achieved by folding back the opposite lateral edges of the carcass ply (101) around the bead wires (102), so as to form the so called carcass back-folds (101a) as shown in FIG. 1.

Alternatively, the conventional bead wires (102) may be replaced with a pair of circumferentially inextensible annular inserts formed from elongate elements arranged in concentric coils (not shown in FIG. 1) (see, for example, European patent applications EP 928 680 and EP 928 702). In this case, the carcass ply (101) is not back-folded around said annular inserts, the coupling being provided by a second carcass ply (not shown in FIG. 1) applied externally onto the first ply.

The carcass ply (101) is generally made of a plurality of reinforcing cords arranged parallel to each other and at least partially coated with a layer of elastomeric compound. These reinforcing cords are usually made of textile fibres such as, for example, rayon, nylon, polyethylene terephthalate, or of steel wires which are stranded together, coated with a metal alloy (for example copper/zinc, zinc/manganese, zinc/molybdenum/cobalt alloys and the like.

According to a preferred embodiment, said carcass ply (101) comprises a plurality of reinforcing cords coated with a vulcanized elastomeric composition comprising at least one elastomeric polymer containing epoxide groups.

The rubberized carcass ply (101) is usually of radial type, that is to say it incorporates reinforcing cords arranged in a substantially perpendicular direction relative to a circumferential direction. Each bead wire (102) is encased in a bead (103), defined along an inner circumferential edge of the tyre (100), with which the tyre engages on a rim (not shown in FIG. 1) forming part of a vehicle wheel. The space defined by each carcass back-fold (101a) contains a bead filler (104), made according to the invention, in which are embedded the bead wires (102). An antiabrasive strip (105) is usually placed in an axially external position relative to the carcass back-fold (101a).

Along the circumference of the rubberized carcass ply (101) is applied a belt structure (106). In the particular embodiment in FIG. 1, the belt structure (106) comprises two belt strips (106a, 106b) which incorporate a plurality of reinforcing cords, typically metal cords, which are parallel to each other in each strip and intersecting with respect to the adjacent strip, oriented so as to form a predetermined angle relative to a circumferential direction. On the radially outermost belt strip (106b) may optionally be applied at least one zero-degree reinforcing layer (106c), commonly known as a “0° belt”, which generally incorporates a plurality of reinforcing cords, typically textile cords, arranged at an angle of a few degrees relative to a circumferential direction, and coated and welded together by means of an elastomeric material.

A sidewall (108) is also applied externally onto the rubberized carcass ply (101), this sidewall extending, in an axially external position, from the bead (103) to the end of the belt structure (106).

A tread band (109), whose lateral edges are connected to the sidewalls (108), is applied circumferentially to the belt structure (106) in a radially external position. Externally, the tread band (109) has a rolling surface (109a) designed to come into contact with the ground. Circumferential grooves which are connected by transverse notches (not shown in FIG. 1) so as to define a plurality of blocks of various shapes and sizes distributed over the rolling surface (109a) are generally made in this surface (109a), which is represented for simplicity in FIG. 1 as being smooth.

A strip made of elastomeric material (110), commonly known as a “mini-sidewall”, may optionally be present in the connecting zone between the sidewalls (108) and the tread band (109), this mini-sidewall generally being obtained by co-extrusion with the tread band and allowing an improvement in the mechanical interaction between the tread band (109) and the sidewalls (108). Alternatively, the end portion of the sidewall (108) directly covers the lateral edge of the tread band (109). A underlayer which forms, with the tread band (109), a structure commonly known as a “cap and base” (not shown in FIG. 1) may optionally be placed between the belt structure (106) and the tread band (109).

A layer of elastomeric material (111) which serves as an “attachment sheet”, i.e. a sheet capable of providing the connection between the tread band (109) and the belt structure (106), may be placed between the tread band (109) and the belt structure (106).

In the case of tubeless tyres, a rubber layer (112) generally known as a “liner”, which provides the necessary impermeability to the inflation air of the tyre, may also be provided in a radially internal position relative to the rubberized carcass ply (101).

The process for producing the tyre according to the present invention may be carried out according to techniques and using apparatus that are known in the art, as described, for example, in patents EP 199 064, U.S. Pat. No. 4,872,822 and U.S. Pat. No. 4,768,937, said process including at least one stage of manufacturing the green tyre and at least one stage of vulcanizing this tyre.

More particularly, the process for producing the tyre comprises the stages of preparing beforehand and separately from each other a series of semi-finished articles corresponding to the various parts of the tyre (carcass plies, belt structure, bead wires, fillers, sidewalls and tread band) which are then combined together using a suitable manufacturing machine. Next, the subsequent vulcanization stage welds the abovementioned semi-finished articles together to give a monolithic block, i.e. the finished tyre.

Naturally, the stage of preparing the abovementioned semi-finished articles is preceded by a stage of preparing and moulding the various mixtures which are the constituents of said semi-finished articles, according to conventional techniques.

The green tyre thus obtained then goes through the subsequent stages of moulding and vulcanization. To this end, a vulcanization mould is used which is designed to receive the tyre being processed inside a moulding cavity having walls which are countermoulded and which define the outer surface of the tyre when the vulcanization is complete.

Alternative processes for producing a tyre or parts of a tyre without using semi-finished articles are disclosed, for example, in the abovementioned patent applications EP 928 680 and EP 928 702.

The green tyre may be moulded by introducing a pressurized fluid into the space defined by the inner surface of the tyre, so as to press the outer surface of the green tyre against the walls of the moulding cavity. In one of the moulding methods widely practised, a vulcanization chamber made of elastomeric material, filled with steam and/or another fluid under pressure, is inflated inside the tyre closed inside the moulding cavity. In this way, the green tyre is pushed against the inner walls of the moulding cavity, thus obtaining the desired moulding. Alternatively, the moulding can be carried out without an inflatable vulcanization chamber, by providing inside the tyre a toroidal metal support shaped according to the configuration of the inner surface of the tyre to be obtained (see, for example, patent EP 242 840). The difference in coefficient of thermal expansion between the toroidal metal support and the crude elastomeric material is exploited to achieve an adequate moulding pressure.

At this point, the stage of vulcanizing the crude elastomeric material present in the tyre is carried out. To this end, the outer wall of the vulcanization mould is placed in contact with heating fluid (generally steam) such that the outer wall reaches a maximum temperature generally of between 100° C. and 230° C. Simultaneously, the inner surface of the tyre is heated to the vulcanization temperature using the same pressurized fluid used to press the tyre against the walls of the moulding cavity, heated to a maximum temperature of between 100° C. and 250° C. The time required to obtain a satisfactory degree of vulcanization throughout the mass of the elastomeric material may vary in general between 3 minutes and 90 minutes and depends mainly on the dimensions of the tyre. When the vulcanization is complete, the tyre is removed from the vulcanization mould.

Although the present invention has been illustrated in relation to a tyre, the vulcanized elastomeric manufactured products described above may be conveyor belts, drive belts, flexible tubes, etc.

The present invention will be further illustrated below by means of a number of preparation examples, which are given for pure indicative purposes and without any limitation of this invention.

### EXAMPLES 1-3

Preparation of the Mixtures

The elastomeric compositions given in Table 1 (the amounts of the various components are expressed in phr) were prepared by mixing together the elastomeric polymers (NR and ENR 25), the carbon black (N375), the fibres (Kevlar® Engineered Elastomer) and the thermosetting resin in a tangential internal mixer for about 5 minutes, reaching a final temperature of about 150° C. Next, said compositions were discharged from the internal mixer, introduced into a laboratory open-mill blender and the other components (given in Table 1) were added: the whole was mixed for about 3 minutes at 100° C.

TABLE 1

| INGREDIENTS | EXAMPLE 1* | EXAMPLE 2* | EXAMPLE 3 |
|---|---|---|---|
| NR | 100.0 | 80.00 | — |
| ENR 25 | — | — | 80.00 |
| KEVLAR ® | — | 26.00 | 26.00 |
| N375 | 75.0 | 75.00 | 75.00 |
| STEARIC ACID | 2.0 | 1.50 | 1.50 |
| ZnO | 10.0 | 6.00 | 6.00 |
| PHENOLIC RESIN | 18.0 | — | — |
| COBALT | 5.7 | — | — |
| NAPHTHENATE | | | |
| AROMATIC OIL | 1.5 | — | — |
| HMT | 1.8 | 1.54 | 1.54 |
| RESORCINOL | — | 1.21 | 1.21 |
| ADHESIVE | 2.0 | 2.00 | 2.00 |
| ANTIOXIDANT | 3.0 | 3.00 | 3.00 |
| TBBS | 1.0 | 1.00 | 1.00 |
| SULPHUR | 7.0 | 3.30 | 3.30 |
| RETARDANT | 0.4 | 0.30 | 0.30 |

*: comparative.
NR: natural rubber;
ENR 25: epoxidized natural rubber containing 25 mol % of epoxide groups (Epoxyprene ® 25 from Guthrie);
Kevlar ® Engineered Elastomer: blend of 23% by weight of Kevlar ® and 77% by weight of natural rubber (Du Pont);
N375: carbon black;
Phenolic resin: octylphenolic resin (Durez ® 29095 from (Occidental);
HMT: hexamethylenetetramine;
Adhesive: t-butylphenol formaldehyde (Durez ® 32333 from (Occidental);
Antioxidant: 6-p-phenylenediamine (Santoflex ® 13 from Monsanto);
TBBS: N-t-butyl-2-benzothiazyl sulphenamide (Vulkacit ® NZ from Bayer);
Retardant: cyclohexylthiophthalimide (Vulkalent ® G from Bayer).

The compositions thus prepared were subjected to MDR rheometric analysis using an MDR rheometer from Monsanto, the tests being carried out at 200° C. for 30 minutes, with an oscillation frequency of 1.66 Hz (100 oscillations per minute) and an oscillation amplitude of ±0.5°. The rheometric properties were measured according to ASTM standard D5289-95.

The percentage of reversion was determined according to the following formula:

$$reversion \% = \frac{{M}_{H} - {M}_{final}}{{M}_{H} - {M}_{L}} \times 100$$

in which:
M_{H}=maximum torque value;
M_{final}=final torque value;
M_{L}=minimum torque value

The Shore D hardness at 23° C. was measured on samples of the abovementioned compositions vulcanized at 150° C. for 30 minutes, according to standard ISO 48. The results are given in Table 2.

Table 2 also gives the elastic properties, measured using an Instron dynamic machine in traction-compression, according to the following methods. To this end, samples of the abovementioned compositions vulcanized at 150° C. for 30 minutes, having a cylindrical shape (length=25 mm; diameter=14 mm), preloaded in compression up to a longitudinal deformation of 10% relative to the initial length, and maintained at a preset temperature (70° C. or 100° C.) throughout the test, were subjected to a dynamic sinusoidal deformation with an amplitude of ±3.33% relative to the length under pre-loading, with a frequency of 100 Hz. The elastic properties are expressed in terms of dynamic elastic modulus values (E′).

Table 2 also gives the load values measured at 50% elongation in the direction of calendering (M1) and in the direction perpendicular thereto (M2). These load values were obtained in accordance with ASTM standard D412, by subjecting samples of Dunbell type, which were obtained by vulcanizing samples of the abovementioned compositions at 150° C. for 30 minutes, to traction.

TABLE 2

| | | | |
|---|---|---|---|
| EXAMPLE | 1* | 2* | 3 |

RHEOMETRIC PROPERTIES

| | | | |
|---|---|---|---|
| M_{L} (dN · m) | 3.06 | 5.47 | 4.59 |
| M_{H} (dN · m) | 67.01 | 47.19 | 55.66 |
| M_{final} (dN · m) | 28.96 | 27.9 | 39.7 |
| TS2 (min) | 0.23 | 0.32 | 0.32 |
| T90 (min) | 0.70 | 0.67 | 0.66 |
| REVERSION (%) | 59.50 | 46.42 | 31.10 |

MECHANICAL PROPERTIES

| | | | |
|---|---|---|---|
| Load M1 at 50% elongation | 8.06 | 11.22 | 14.74 |
| in the direction of | | | |
| calendering (MPa) | | | |
| Load M2 at 50% elongation | 7.50 | 7.88 | 10.51 |
| in the direction | | | |
| perpendicular to | | | |
| calendering (MPa) | | | |
| M1/M2 | 1.07 | 1.42 | 1.40 |

ELASTIC PROPERTIES

| | | | |
|---|---|---|---|
| E′ (70° C.) (MPa) | 59.59 | 25.36 | 35.58 |
| E′ (100° C.) (MPa) | 47.61 | 23.02 | 30.70 |
| Shore D hardness at 23° C. | 48.00 | 51.00 | 55.00 |

*: comparative.

From the experimental results given in Table 2, it may be seen that the use of epoxidized natural rubber makes it possible to obtain elastomeric compositions which have improved mechanical properties, in particular a better load at elongation, and better elastic properties, in particular a better dynamic elastic modulus at high temperature, and also a lower percentage of reversion with respect to the comparative elastomeric compositions.

### EXAMPLE 4

Evaluation of the Performance Qualities on the Road

Tyres according to the invention of the type Pirelli® P3000® 175/65 R14 were prepared using, as bead filler, the compositions of Example 1 (comparative) and of Example 3.

The following tests were carried out: handling on wet surface, straight-line driving, behaviour driving at normal speed (soft handling), behaviour at the limit of adherence (hard handling) and comfort. The term “hard handling” indicates the execution by the test driver of all the manoeuvres that an average driver may be forced to carry out in the case of unforeseen and hazardous situations: sharp steering at high speed, sudden changes of direction and of driving to avoid obstacles, sharp braking and the like.

The abovementioned tests were carried out at the Vizzola Ticino test track as regards the wet surface tests (road holding on a wet surface and track lap time on a wet surface), and at the Imola test track as regards the dry surface tests, the tyres being mounted on a 1400 cc Fiat Brava car.

The reference tyres and test tyres were tested by an independent pair of test drivers who subsequently awarded the tyres a grade from 0 to 10 based on their subjective opinion for each test carried out. Once the grading was complete, an index of 100 was given to the reference tyres. A percentage increase in the index was then assigned to the test tyres in proportion to the improvement in performance qualities during the test. In other words, the higher the index, the better the performance qualities offered by the tyre under examination.

The test results, expressed as the average of the grades awarded by the two test drivers, are given in Table 3.

TABLE 3

| TESTS | EXAMPLE 1* | EXAMPLE 3 |
|---|---|---|
| Wet surface handling | 100 | 113 |
| Lap time on a wet | 100 | 101 |
| surface | | |
| Straight-line driving | 100 | 117 |
| Soft handling | 100 | 119 |
| Hard handling | 100 | 114 |
| Comfort | 100 | 103 |

*: comparative.

The data given above demonstrate that the tyre with the bead filler according to the present invention is capable of offering better performance qualities than the tyre with the comparative bead filler as regards wet surface handling, straight-line driving and the handling, while keeping the performance qualities substantially identical as regards the track lap time on a wet surface and the comfort.

1. Tyre for vehicle wheels comprising:
a carcass structure having at least one carcass ply shaped in a substantially toroidal configuration, the opposite lateral edges of which are associated with respective left and right bead wires, each bead wire being enclosed in a respective bead, said bead comprising a bead filler, wherein
said bead filler is obtained by vulcanization of an elastomeric composition comprising discontinuous fibres and at least one elastomeric Polymer containing epoxide groups;
a belt structure comprising at least one belt strip applied circumferentially over said carcass structure;
a tread band circumferentially superimposed on said belt structure; and
a pair of sidewalls applied laterally on opposite sides relative to said carcass structure.

2. Tyre according to claim 1, in which the discontinuous fibres are aramid fibres.

3. Tyre according to claim 2, in which the aramid fibres are short fibrillated poly (para-phenylene-terephthalamide) fibres.

4. Tyre according to claim 2, in which the aramid fibres are predispersed in a polymer matrix chosen from: natural rubber, butadiene/styrene copolymers, or ethylene/vinyl acetate copolymers.

5. Tyre according to claim 4, in which the polymer matrix is natural rubber.

6. Tyre according to claim 1, in which the discontinuous fibres are derived from polyamides other than aramids, polyesters, polyolefins, polyvinyl alcohols, or glass fibres.

7. Tyre according to claim 1, in which the discontinuous fibres are present in an amount of between 2 phr and 12 phr.

8. Tyre according to claim 7, in which the discontinuous fibres are present in an amount of between 4 phr and 10 phr.

9. Tyre according to claim 1, in which the elastomeric polymer containing epoxide groups is a homopolymer or copolymer with elastomeric properties having a glass transition temperature (Tg) of less than 23° C.

10. Tyre according to claim 1, in which the elastomeric polymer containing epoxide groups contains at least 0.05 mol % of epoxide groups relative to the total number of moles of monomers present in the polymer.

11. Tyre according to claim 10, in which the elastomeric polymer containing epoxide groups contains from 1 mol % to 70 mol % of epoxide groups relative to the total number of moles of monomers present in the polymer.

12. Tyre according to claim 1, in which the elastomeric polymer containing epoxide groups has an average molecular weight of between 10,000 and 1,000,000.

13. Tyre according to claim 12, in which the elastomeric polymer containing epoxide groups has an average molecular weight of between 50,000 and 500,000.

14. Tyre according to claim 1, in which the elastomeric polymer containing epoxide groups is an epoxidized diene homopolymer or copolymer having a base polymer structure, in which the base polymer structure is derived from one or more conjugated diene monomers, optionally copolymerized with monovinylarenes and/or polar comonomers.

15. Tyre according to claim 14, in which the base polymer structure is chosen from: natural rubber, polybutadiene, polyisoprene, styrene/butadiene copolymers, butadiene/isoprene copolymers, styrene/isoprene copolymers, nitrile rubbers, or blends thereof.

16. Tyre according to claim 13, in which the elastomeric polymer containing epoxide groups is chosen from elastomeric copolymers of one or more monoolefins with an olefinic comonomer containing one or more epoxide groups.

17. Tyre according to claim 1, in which the elastomeric polymer containing epoxide groups is epoxidized natural rubber.

18. Tyre according to claim 1, in which the elastomeric polymer containing epoxide groups is present in an amount of between 30 phr and 100 phr.

19. Tyre according to claim 18, in which the elastomeric polymer containing epoxide groups is present in an amount of between 50 phr and 100 phr.

20. Tyre according to claim 19, in which the elastomeric polymer containing epoxide groups is present in an amount of between 70 phr and 100 phr.

21. Tyre according to claim 1, in which the elastomeric composition further comprises at least one diene elastomer not containing epoxide groups.

22. Tyre according to claim 21, in which the diene elastomer not containing epoxide groups is chosen from: natural rubber; polybutadiene; polyisoprene; styrene/butadiene copolymers; butadiene/isoprene copolymers; styrene/isoprene copolymers; butyl rubbers or halobutyl rubbers; ethylene/propylene copolymers; ethylene/propylene/non-conjugated diene terpolymers; or blends thereof.

23. Tyre according to claim 22, in which the diene elastomer not containing epoxide groups is natural rubber or polyisoprene.

24. Tyre according to claim 21, in which the diene elastomer not containing epoxide groups is present in an amount of between 0 phr and 70 phr.

25. Tyre according to claim 24, in which the diene elastomer not containing epoxide groups is present in an amount of between 10 phr and 50 phr.

26. Tyre according to claim 1, in which the elastomeric composition further comprises at least one reinforcing filler chosen from carbon black, silica, alumina, aluminosilicates, calcium carbonate, kaolin, or mixtures thereof.

27. Tyre according to claim 26, in which the reinforcing filler is carbon black.

28. Tyre according to claim 26, in which the reinforcing filler is present in an amount of between 50 phr and 150 phr.

29. Tyre according to claim 28, in which the reinforcing filler is present in an amount of between 60 phr and 100 phr.

30. Tyre according to claim 1, in which the elastomeric composition further comprises at least one thermosetting resin.

31. Tyre according to claim 30, in which the thermosetting resin is of the two-component type.

32. Tyre according to claim 30, in which the thermosetting resin is of the precondensed type.

33. Tyre according to claim 30, in which the thermosetting resin is present in an amount of between 0.5 phr and 15 phr.

34. Tyre according to claim 33, in which the thermosetting resin is present in an amount of between 2 phr and 10 phr.

35. Tyre according to claim 1, in which the carcass ply further comprises a plurality of reinforcing cords coated with a vulcanized elastomeric composition comprising at least one elastomeric polymer containing epoxide groups.

36. Tyre according to claim 35, in which the elastomeric polymer containing epoxide groups is a homopolymer or copolymer with elastomeric properties having a glass transition temperature (Tg) of less than 23° C.

37. Elastomeric composition comprising:
discontinuous fibres, and
at least one polymer containing epoxide groups.

38. Elastomeric composition according to claim 37, in which the elastomeric polymer containing epoxide groups is a homopolymer or copolymer with elastomeric properties having a glass transition temperature (Tg) of less than 23° C.

39. Elastomeric composition according to claim 37, further comprising at least one diene elastomer not containing epoxide groups.

40. Elastomeric composition according to claim 39, in which the diene elastomer not containing epoxide groups is chosen from: natural rubber; polybutadiene; polyisoprene; styrene/butadiene copolymers; butadiene/isoprene copolymers; styrene/isoprene copolymers; butyl rubbers or halobutyl rubbers; ethylene/propylene copolymers; ethylene/propylene/non-conjugated diene terpolymers; or blends thereof.

41. Elastomeric composition according to claim 39, further comprising at least one reinforcing filler.

42. Elastomeric composition according to claim 41, in which the reinforcing filler is chosen from carbon black, silica, alumina, aluminosilicates, calcium carbonate, kaolin, or mixtures thereof.

43. Elastomeric composition according to claim 39, further comprising at least one thermosetting resin.

44. Elastomeric composition according to claim 43, in which the thermosetting resin is of the two-component type.

45. A vulcanized elastomeric manufactured product obtained by a process comprising vulcanizing an elastomeric composition of claim 39.

46. Elastomeric composition according to claim 39, in which the diene elastomer not containing epoxide groups is present in an amount of between 0 phr and 70 phr.

47. Elastomeric composition according to claim 46, in which the diene elastomer not containing epoxide groups is present in an amount of between 10 phr and 50 phr.

48. Elastomeric composition according to claim 41, in which the reinforcing filler is present in an amount of between 50 phr and 150 phr.

49. Elastomeric composition according to claim 48, in which the reinforcing filler is present in an amount of between 60 phr and 100 phr.

50. Elastomeric composition according to claim 43, in which the thermosetting resin is of the precondensed type.

51. Elastomeric composition according to claim 43, in which the thermosetting resin is present in an amount of between 0.5 phr and 15 phr.

52. Elastomeric composition according to claim 51, in which the thermosetting resin is present in an amount of between 2 phr and 10 phr.

53. Tyre according to claim 35, in which the elastomeric polymer containing epoxide groups contains at least 0.05 mol % of epoxide groups relative to the total number of moles of monomers present in the polymer.

54. Tyre according to claim 53, in which the elastomeric polymer containing epoxide groups contains from 1 mol % to 70 mol % of epoxide groups relative to the total number of moles of monomers present in the polymer.

55. Tyre according to claim 35, in which the elastomeric polymer containing epoxide groups has an average molecular weight of between 10,000 and 1,000,000.

56. Tyre according to claim 55, in which the elastomeric polymer containing epoxide groups has an average molecular weight of between 50,000 and 500,000.

57. Tyre according to claim 35, in which the elastomeric polymer containing epoxide groups is an epoxidized diene homopolymer or copolymer having a base polymer structure, in which the base polymer structure is derived from one or more conjugated diene monomers, optionally copolymerized with monovinylarenes and/or polar comonomers.

58. Tyre according to claim 57, in which the base polymer structure is chosen from: natural rubber, polybutadiene, polyisoprene, styrene/butadiene copolymers, butadiene/isoprene copolymers, styrene/isoprene copolymers, nitrile rubbers, or blends thereof.

59. Tyre according to claim 35, in which the elastomeric polymer containing epoxide groups is chosen from elastomeric copolymers of one or more monoolefins with an olefinic comonomer containing one or more epoxide groups.

60. Tyre according to claim 35, in which the elastomeric polymer containing epoxide groups is epoxidized natural rubber.

61. Tyre according to claim 35, in which the elastomeric polymer containing epoxide groups is present in an amount of between 30 phr and 100 phr.

62. Tyre according to claim 61, in which the elastomeric polymer containing epoxide groups is present in an amount of between 50 phr and 100 phr.

63. Tyre according to claim 62, in which the elastomeric polymer containing epoxide groups is present in an amount of between 70 phr and 100 phr.

64. Tyre according to claim 37, in which the elastomeric polymer containing epoxide groups contains at least 0.05 mol % of epoxide groups relative to the total number of moles of monomers present in the polymer.

65. Tyre according to claim 53, in which the elastomeric polymer containing epoxide groups contains from 1 mol % to 70 mol % of epoxide groups relative to the total number of moles of monomers present in the polymer.

66. Tyre according to claim 37, in which the elastomeric polymer containing epoxide groups has an average molecular weight of between 10,000 and 1,000,000.

67. Tyre according to claim 66, in which the elastomeric polymer containing epoxide groups has an average molecular weight of between 50,000 and 500,000.

68. Tyre according to claim 37, in which the elastomeric polymer containing epoxide groups is an epoxidized diene homopolymer or copolymer having a base polymer structure, in which the base polymer structure is derived from one or more conjugated diene monomers, optionally copolymerized with monovinylarenes and/or polar comonomers.

69. Tyre according to claim 68, in which the base polymer structure is chosen from: natural rubber, polybutadiene, polyisoprene, styrene/butadiene copolymers, butadiene/isoprene copolymers, styrene/isoprene copolymers, nitrile rubbers, or blends thereof.

70. Tyre according to claim 37, in which the elastomeric polymer containing epoxide groups is chosen from elastomeric copolymers of one or more monoolefins with an olefinic comonomer containing one or more epoxide groups.

71. Tyre according to claim 37, in which the elastomeric polymer containing epoxide groups is epoxidized natural rubber.

72. Tyre according to claim 37, in which the elastomeric polymer containing epoxide groups is present in an amount of between 30 phr and 100 phr.

73. Tyre according to claim 72, in which the elastomeric polymer containing epoxide groups is present in an amount of between 50 phr and 100 phr.

74. Tyre according to claim 73, in which the elastomeric polymer containing epoxide groups is present in an amount of between 70 phr and 100 phr.
